(19) United States
(12) Patent Application Publication
(10) Pub. No.: US 2025/0145152 A1
(43) Pub. Date: May 8, 2025

(54) DRIVING ASSISTANCE APPARATUS FOR VEHICLE

(71) Applicant: TOYOTA JIDOSHA KABUSHIKI KAISHA, Toyota-shi (JP)

(72) Inventor: KAZUKI HIRAMOTO, Susono-shi (JP)

(73) Assignee: TOYOTA JIDOSHA KABUSHIKI KAISHA, Toyota-shi (JP)

(21) Appl. No.: 18/894,975

(22) Filed: Sep. 24, 2024

(30) Foreign Application Priority Data
Nov. 2, 2023 (JP) 2023-188274

(51) Int. Cl. B60W 30/09

(52) U.S. Cl. CPC B60W 30/09; B60W 2554/4041; B60W 2554/802; B60W 2556/45

(57) ABSTRACT

A driving assistance ECU (10) of a driving assistance apparatus performs a first assistance control which is a standard driving assistance control based on electronic data stored in a memory before factory shipment of a host vehicle, when the host vehicle is located in a normal region other than a specific region. The driving assistance ECU performs, in place of the first assistance control, a second assistance control which is a driving assistance control for the specific region using electronic data that is received from a server (100a) external to the host vehicle, when the host vehicle is located in the specific region.

### CROSS-REFERENCE TO RELATED APPLICATIONS

This application claims priority to Japanese patent application No. JP 2023-188274 filed on Nov. 2, 2023, the content of which is hereby incorporated by reference in its entirety.

### TECHNICAL FIELD

The present disclosure relates to a driving assistance apparatus for a vehicle which is capable of performing driving assistance control suitable/appropriate for characteristics of a specific region (i.e., specific areas).

### BACKGROUND

Conventional apparatuses for executing various driving assistance controls have been known. For example, one of them (hereinafter, referred to as a “conventional apparatus”), disclosed in Japanese Patent Application Laid-Open No. 2019-130996, has stored in its memory a map or function that defines a plurality of regions around an object (e.g., a parked other vehicle) in advance. This map or function associates each of a plurality of the regions with an upper limit value of a relative speed between a host vehicle and the object. When the host vehicle approaches the object and enters any one of the aforementioned regions, the conventional apparatus controls the speed of the host vehicle in such a manner that the relative speed between the host vehicle and the object does not exceed “the upper limit of the relative speed associated with the region” which the host vehicle enters. Furthermore, the conventional apparatus switches the above-mentioned map or function based on the host vehicle's position obtained from positioning system. Therefore, the conventional apparatus enables the host vehicle to overtake the object at a “relative speed appropriate to the characteristics of the region”.

### SUMMARY

It is necessary for the above-described conventional apparatus to have stored in the memory all of the maps or functions that had been determined/developed before the host vehicle was introduced to the market. However, it is not viable to prepare “maps, functions, and programs” for an extremely large number of regions in advance and store them in the memory of the host vehicle's controller, at the design stage of the host vehicle. Furthermore, since the memory of the controller has storage capacity limitations, it is also difficult to store the “maps, functions, and programs” for the extremely large number of the regions in advance. The present disclosure is made to cope with these problems.

One of embodiments of a driving assistance apparatus of a vehicle according to the present disclosure (hereinafter, referred to as a “present disclosure apparatus”) comprises a controller (10).

The controller is configured to:

when a host vehicle is located in a normal region other than a specific region, perform a first assistance control which is a standard driving assistance control based on electronic data stored in a memory before factory shipment of the host vehicle (S320); and

when the host vehicle is located in the specific region, perform, in place of the first assistance control, a second assistance control which is a driving assistance control for the specific region using (i.e., based on) electronic data that is received from a server (100a) external to the host vehicle (S340).

According to the embodiment, when the host vehicle is located in the specific region, the second assistance control is performed based on the electronic data that is received from a server (100a). Therefore, it is not necessary to develop driving assistance controls appropriate/suitable for an extremely large number of specific regions at a developing stage of the host vehicle and to store, in the memory of the host vehicle, all electronic data required to perform the developed driving assistance controls in advance. Furthermore, at least before the time that the host vehicle passes the specific region, it is sufficient that the electronic data for performing the driving assistance control suitable for that specific region becomes available for the controller. Thus, it is unnecessary to hold in the memory of the host vehicle all the electronic data to perform the driving assistance controls suitable for an extremely large number of specific regions. From the above, the present disclosure apparatus is capable of performing appropriate driving assistance controls for various specific regions.

Notably, in the above description, in order to facilitate understanding of the present disclosure, the constituent elements corresponding to those of an embodiment which will be described later are accompanied by parenthesized symbols and/or names which are used in the embodiment; however, the constituent elements of the disclosure are not limited to those in the embodiment defined by the symbols and/or names. The present disclosure also covers a driving assistance method for a vehicle and a program thereof.

### BRIEF DESCRIPTION OF THE DRAWINGS

FIG. 1 is a schematic diagram of a driving assistance apparatus of a vehicle according to an embodiment of the present disclosure.

FIG. 2 shows a routine executed by a CPU of a driving assistance ECU shown in FIG. 1.

FIG. 3 shows a routine executed by the CPU of the driving assistance ECU shown in FIG. 1.

FIG. 4 shows a routine executed by the CPU of the driving assistance ECU shown in FIG. 1.

FIG. 5A is a figure for describing a driving assistance control optimized for a specific region.

FIG. 5B is a figure for describing another driving assistance control optimized for another specific region.

FIG. 6 shows a routine executed by a CPU of a driving assistance ECU of a modification according to the present disclosure.

### DETAILED DESCRIPTION

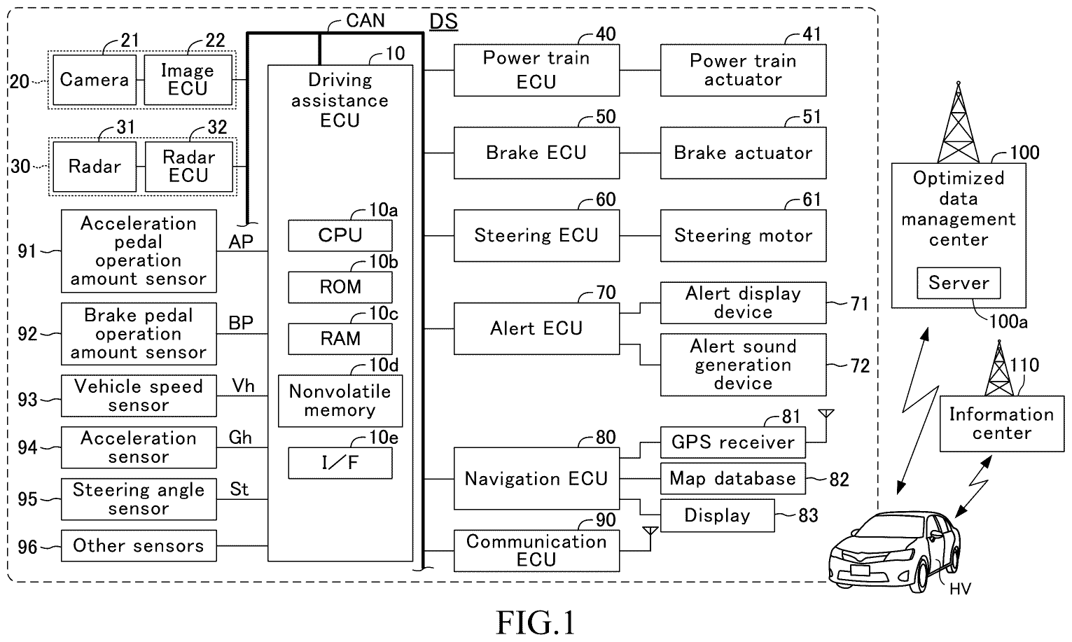

A driving assistance apparatus DS of a vehicle (hereinafter, referred to as an “apparatus DS”) according to an embodiment of the present disclosure comprises components/elements illustrated in FIG. 1. The apparatus DS is applied to and is mounted on a host vehicle HV. The host vehicle HV may be a vehicle having an internal combustion engine as a drive source, a vehicle having an electric motor as the drive source (namely, an electric vehicle), or a hybrid vehicle.

In the present specification, an “ECU” means an electronic control unit (i.e., control unit). The ECU includes a microcomputer which comprises a CPU (i.e., processor), storing devices such as a ROM, a RAM, and a data writable involatile memory, and an interface. The ECU may sometimes be referred to as a “controller” or a “computer”. A plurality of ECUs shown in FIG. 1 are connected to each other through Controller Area Network (CAN) in such a manner that they can exchange information with each other. All of or some of a plurality of those ECUs may be integrated into a single ECU.

A driving assistance (or support) ECU 10 performs a driving assistance control using the components shown in FIG. 1. As will be described in detail later, when the host vehicle HV is driving in a specific region, the driving assistance ECU 10 performs wireless communication with the optimization data management center (hereinafter referred to as the “management center”) 100 external to the host vehicle HV to obtain “optimized data (electronic information) for the specific region” from the server 100a of the management center 100. The driving assistance ECU 10 utilizes the optimized data to perform the driving assistance control appropriate/suitable for the specific region. This optimized data is electronic information such as look up table data (map data), functions, control constants, parameters, and programs, and is used to perform the driving assistance control appropriate/suitable for the specific region by the CPU 10a of the driving assistance ECU 10. The driving assistance ECU 10 comprises the microcomputer that includes the CPU 10a, the ROM 10b, the RAM 10c, the involatile writable memory 10d that can hold data while electric power is not provided, and the interface 10e.

A peripheral camera system 20 includes a camera 21 and an image ECU 22. The camera 21 captures (or takes a picture of) a scene around the host vehicle HV so as to obtain image data, every time a predetermined time elapses. The image ECU 22 produces camera information by analyzing the image data sent from the camera 21, and transmits the camera information to the driving assistance ECU 10. The camera information includes the image data itself, and information including “a position relative to the host vehicle HV, a relative longitudinal speed, a relative lateral speed, and type” of an object that is captured.

The radar device 30 is a well-known device configured to obtain information on an object that is present around the host vehicle HV, using electrical waves in a millimeter waveband, and includes a radar 31 and a radar ECU 32. The radar 31, every time a predetermined time elapses, transmits electrical waves into a predetermined detection area and receives electrical waves reflected at an object. The radar 31 transmits information on transmitted electrical waves and on received electrical waves to the radar ECU 32. The radar ECU 32 obtains radar information based on the information sent from the radar 31, and transmits the radar information to the driving assistance ECU 10. The radar information includes a distance to the object, an azimuth of the object, and a relative speed of the object.

A powertrain ECU 40 drives a power train actuator 41 to thereby control a driving device including the driving source of the unillustrated host vehicle HV so as to cause the driving device to generate a driving force.

A brake ECU 50 drives a brake actuator 51 to thereby control an unillustrated brake device of the host vehicle HV so as to apply a brake force to the host vehicle HV.

A steering ECU 60 drives a steering motor 61 to thereby control an unillustrated steering device to change a steering angle of the host vehicle HV.

An alert ECU 70 causes an alert/warning display device 71 to display an alert/warning, and causes an alert sound generation device 72 to generate an alert sound, in response to an instruction (i.e., instruction signal) sent from the driving assistance ECU 10.

A navigation ECU 80 is connected to a GPS receiver 81, a map database 82, and a display touch panel 83 that can display touch buttons, to constitute an on-board navigation system together with these elements. The navigation ECU 80 estimates/obtains a current position of the host vehicle HV based on GPS signals received by the GPS receiver 81. When a destination is set through the display touch panel 83, the navigation ECU 80 produces a recommended route to the destination from the current position based on the map data stored in the map database 82.

The navigation ECU 80 sets the recommended route as a planned travel route and performs the well-known route guide. Furthermore, the navigation ECU 80 obtains the latest map data from the information center 110 through a communication ECU 90 described later, and updates the map data stored in the map database 82 based on the latest map data. The obtained latest map data includes: data which specifies a specific region where optimized data is available; volume of the optimized data; and time length required for the vehicle HV to download the optimized data from the management center 100. The specific region where optimized data is available is simply referred to as a “specific region”, hereinafter.

The communication ECU 90 performs a wireless communication with an external devise (e.g., a road side device, the management center 100, the information center 110, or the like) to thereby obtain various information from the external devise.

The driving assistance ECU 10 receives detected values (output values) of sensors and switches described below.

An acceleration pedal operation amount sensor 91 that detects an acceleration pedal operation amount AP of the host vehicle HV.

A brake pedal operation amount sensor 92 that detects a brake pedal operation amount BP of the host vehicle HV.

A vehicle speed sensor 93 that detects a speed of the host vehicle HV (i.e., host vehicle speed Vh).

An acceleration sensor 94 that detects an acceleration Gh in a front-rear direction of the host vehicle HV.

A steering angle sensor 95 that detects a steering angle St of the host vehicle HV.

The other sensors including a yaw rate sensor and a steering torque sensor.

### (Outline of Operation)

When the host vehicle HV is located in a normal region (that is a region other than the specific region), the apparatus DS performs a first assistance control that is a standard driving assistance control based on the electronic data stored indelibly in the memory (i.e., the ROM 10b) in advance before factory shipment of the host vehicle HV. When the host vehicle HV runs in the specific region where the first assistance control is not appropriate/suitable but the second assistance control is appropriate/suitable as the driving assistance control, the apparatus DS receives in advance the optimized data from the optimized data management center 100, and performs the second assistance control using the optimized data.

### (Specific Operation)

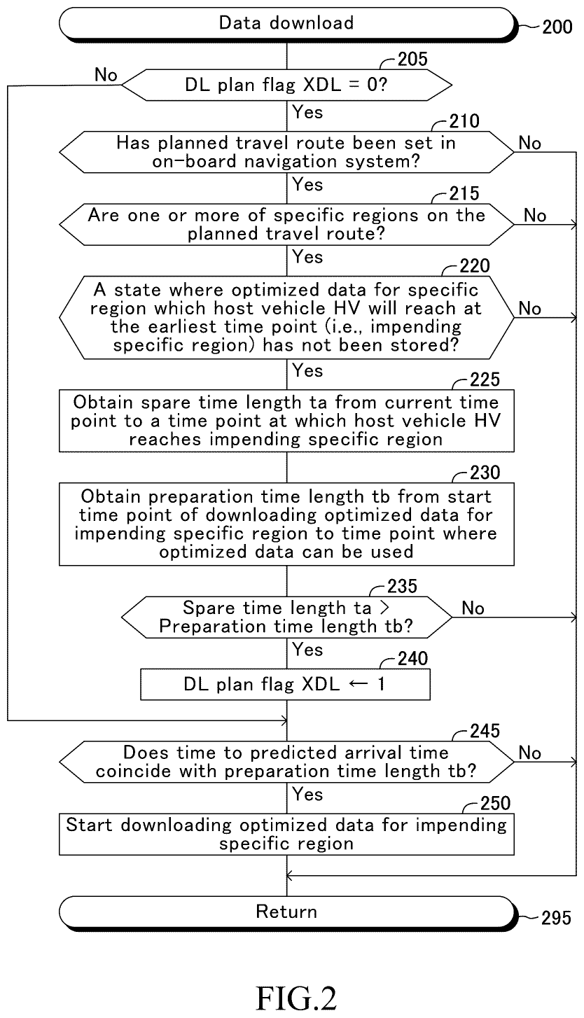

The CPU 10a of the driving assistance ECU 10 (hereinafter, simply referred to as a “CPU”) executes routines shown by flowcharts in FIGS. 2-5, every time a predetermined time (calculation cycle) dt elapses.

### <Download of the Optimized Data>

Hereinafter, “step” is expressed as “S”. When an appropriate time point comes, the CPU starts processing from S200 shown in FIG. 2, and proceeds to S205, and determines whether or not a value of a DL plan flag XDL is “0”. The DL plan flag XDL is set to “1” when downloading the optimized data is planned (refer to S240 described later). The value of the DL plan flag XDL is set to “0” by an initializing routine executed by the CPU when an unillustrated ignition key switch of the host vehicle VH is switched from an off position to an on position.

When the value of the DL plan flag XDL is “0”, the CPU proceeds to S205 from S210, and determines whether or not a planned travel route has been set in the on-board navigation system. When the planned travel route has been set in the on-board navigation system, the CPU proceeds to S215 from S210 to determine, based on the map data, whether or not there is one or more of the specific regions where the optimized data can be utilized (or available) in an area from the current position of the host vehicle HV to the destination, along the planned travel route.

When the planned travel route goes through one or more of the specific regions, the CPU proceeds to S220 from S215 to determine whether the optimized data for an impending specific region has not been stored/held in the involatile memory 10d of the driving assistance ECU 10. The impending specific region is a region among the specific regions through which the host vehicle HV travel that the host vehicle HV will reach at the earliest time point.

When the optimized data for the impending specific region has not been stored/held in the involatile memory 10d, the CPU proceeds to S225 from S220 to obtain/estimate, as a spare time length ta, a time length from a current time point to a time point at which the host vehicle HV reaches the impending specific region, from the navigation ECU 80.

Subsequently, the CPU proceeds to S230 to obtain a first time required to download the optimized data for the impending specific region and the volume of the optimized data, from the “management center 100 including the server 100a that delivers the optimized data for the impending specific region”, through the communication ECU 90 and the information center 110. Alternatively, the CPU may obtain the above-described information from the map database 82 through the navigation ECU 80. Furthermore, the CPU obtains (calculates) second time from a time point at which the download of the optimized data for the impending specific region is completed to a time point at which the downloaded optimized data comes to be able to be used after setting (e.g., installing) the downloaded optimized data. Then, the CPU obtains the sum of the first time and the second time as a preparation time length tb.

Subsequently, the CPU proceeds to S235 to determine whether or not the spare time length ta is longer than the preparation time length tb. When the spare time length ta is longer than the preparation time length tb, the CPU proceeds to S240 to set the value of the DL plan flag XDL to “1”. It should be noted that the value of the DL plan flag XDL is returned to “0” when the download of the optimized data for the impending specific region is completed.

Subsequently, the CPU proceeds to S245 to determine whether or not the present time has coincided with the time which is the preparation time length tb before the time point (i.e., predicted arrival time) at which the host vehicle HV is predicted to reach the impending specific region. When the present time has coincided with the time which is the preparation time length tb before the time at which the host vehicle HV is predicted to reach the impending specific region, the CPU proceeds to S250 from S245 to start downloading the optimized data for the impending specific region. After downloading the optimized data for the impending specific region is completed, the CPU performs setting (e.g., installing) the downloaded optimized data so that the downloaded optimized data can be utilized by the CPU. Whereas, when the present time has not coincided with the time which is the preparation time length tb before the time at which the host vehicle HV is predicted to reach the impending specific region, the CPU directly proceeds to S295 from S245 to terminate the present routine tentatively.

It should be noted that if the value of the DL plan flag XDL is not “0” (i.e., is “1”) when the CPU proceeds to S205 next time, the CPU directly proceeds to S245 from S205. In addition, when the CPU makes a “No” determination at any of S210, S215, S220, and S235, it directly proceeds to S295 from the step at which the “No” determination is made.

### <Performing the Driving Assistance Control>

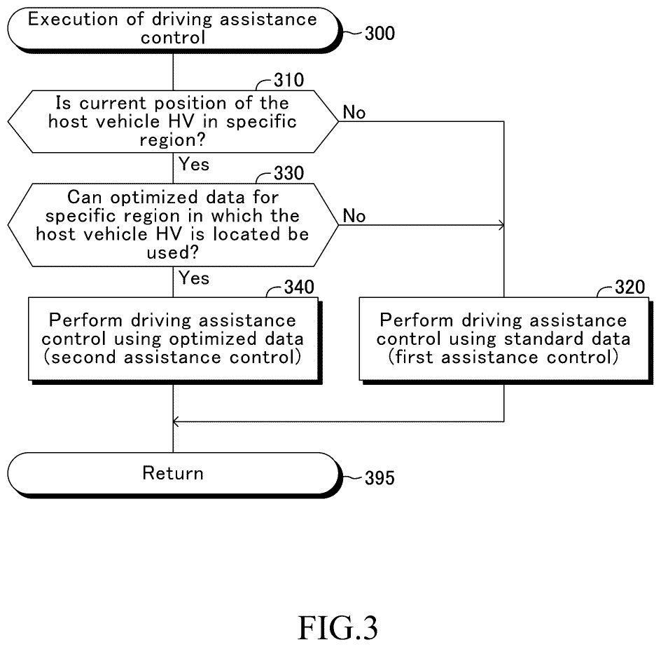

When an appropriate time point comes, the CPU starts processing from S300 shown in FIG. 3, and proceeds to S310 to determine whether or not the current position of the host vehicle HV is in any of the specific regions. When the current position of the host vehicle HV is not in any of the specific regions, the CPU proceeds to S320 from S310 to perform the standard driving assistance control based on standard data (i.e., the look up table data (map data), the functions, the control constants, the parameters, the programs, or the like) stored indelibly in the ROM 10b in advance (i.e., before the factory shipment of the host vehicle HV). This standard driving assistance control may be referred to as a usual driving assistance control or the first assistance control. Thereafter, the CPU proceeds to S395 to terminate the present routine tentatively.

When the current position of the host vehicle HV is in any of the specific regions, the CPU proceeds to S330 from S310 to determine whether or not the optimized data (i.e., the look up table data (map data), the functions, the control constants, the parameters, the programs, or the like) for the specific region in which the host vehicle HV is located is in a state where it can be used by the CPU of the ECU 10. If the optimized data is not in the state where it can be used by the CPU of the ECU 10, the CPU proceeds to S320 from S330. At S320, the CPU performs the standard driving assistance control based on the standard data.

Whereas, when the optimized data is in the state where it can be used by the CPU of the ECU 10, the CPU proceeds to S340 from S330. At S340, the CPU performs a driving assistance control optimized for the specific region in which the host vehicle HV is located based on the optimized data for that region. This driving assistance control may be referred to as the second assistance control. Thereafter, the CPU proceeds to S395.

### <Holding or Deleting of the Downloaded Optimized Data>

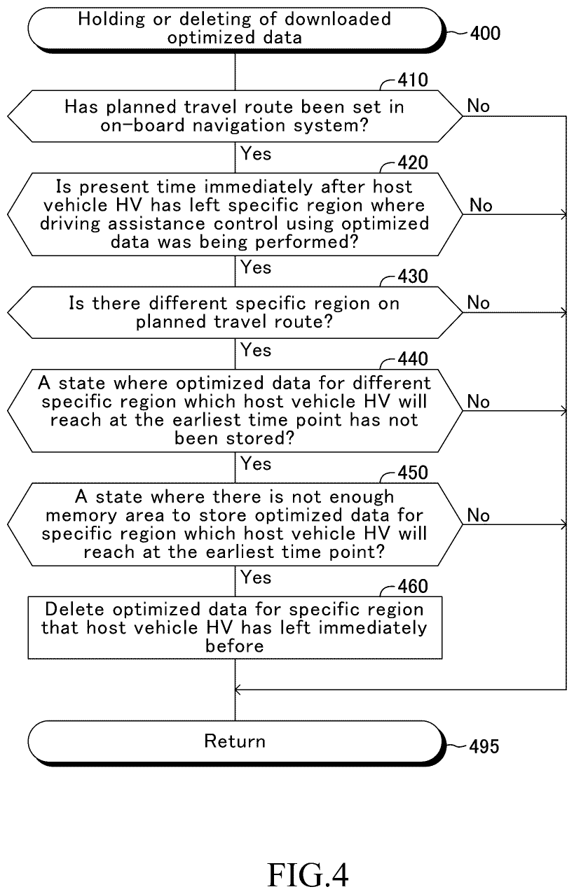

When an appropriate time point comes, the CPU starts processing from S400 shown in FIG. 4, and proceeds to S410 to determine whether or not the planned travel route has been set in the on-board navigation system. When the planned travel route has been set in the on-board navigation system, the CPU proceeds to S420 from S410 to determine whether or not the present time is immediately after the host vehicle HV has left the specific region where the CPU was performing based on the optimized data, the driving assistance control (the second assistance control).

When the present time point is immediately after the host vehicle HV has left the specific region, the CPU proceeds to S430 from S420 to determine whether or not there is different one or more of the specific regions in an area from the current position of the host vehicle HV to the destination, along the planned travel route that has been set in the on-board navigation system.

When there is one or more of the specific regions, the CPU proceeds to S440 from S430 to determine whether or not the optimized data for one of the specific regions that the host vehicle HV will reach at the earliest time point has not been stored/held in the involatile memory 10d.

When the optimized data for one of the specific regions that the host vehicle HV will reach at the earliest time point has not been stored/held in the involatile memory 10d, the CPU proceeds from S440 to S450. At step S450, the CPU determines whether or not the involatile memory 10d does not have enough memory area (i.e., memory capacity) to store the optimized data for the specific region that the host vehicle HV will reach at the earliest time point.

When the involatile memory 10d does not have the above-described memory area (i.e., memory capacity), the CPU proceeds to S460 from S450 to delete, from the involatile memory 10d, the optimized data for the specific region that the host vehicle HV has left immediately before. Thereafter, the CPU proceeds to S495 to terminate the present routine tentatively. It should be noted that, even after the optimized data for the specific region that the host vehicle HV has left immediately before is deleted from the involatile memory 10d, the CPU deletes the electric data stored in the involatile memory 10d from the newer electronic data in order till the memory area is secured to store the optimized data for the specific region that the host vehicle HV will reach at the earliest time point, if the memory area (i.e., memory capacity) cannot be secured to store the optimized data for the specific region that the host vehicle HV will reach at the earliest time point.

Notably, when the CPU makes a “No” determination at any of the step from S410 to S450, the CPU directly proceeds to S495 from the step at which the CPU makes the “No” determination.

### <Examples of the Standard Driving Assistance Control (i.e., First Assistance Control) and the Driving Assistance Control Optimized for the Specific Region (i.e., Second Assistance Control)>

### (Example 1) Collision Avoidance Assistance Control (Collision Damage Mitigation Control)

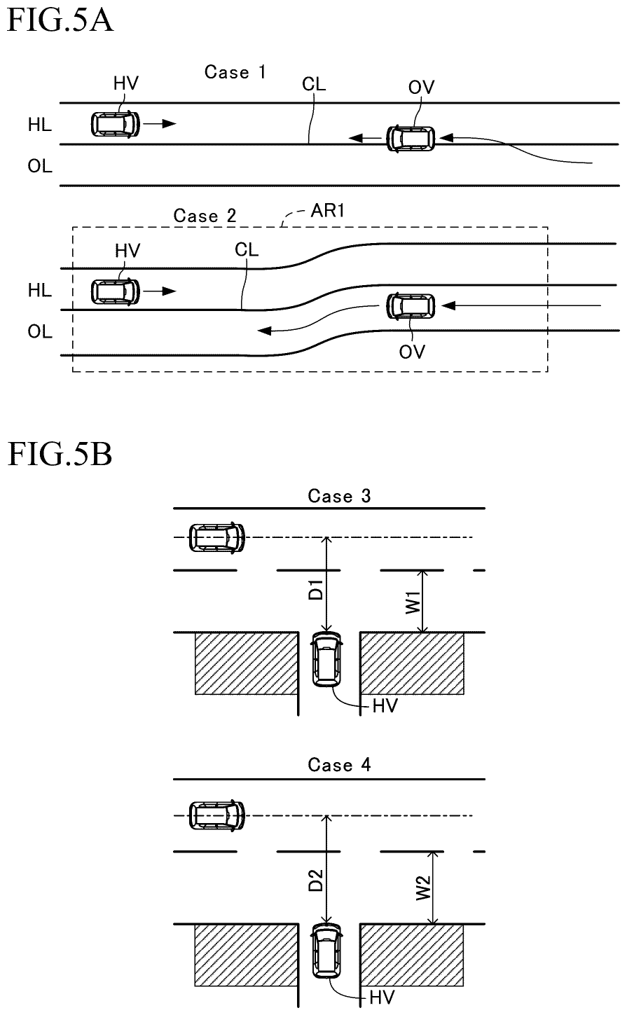

In the case 1 shown in FIG. 5A, another vehicle OV, which is an oncoming vehicle, has crossed the center line CL from the oncoming lane OL into the travel lane HL of the host vehicle HV, and therefore, there is a possibility that another vehicle OV collides with the host vehicle HV. In this case, when the margin time TTC(=distance between the host vehicle HV and the other vehicle OV/relative speed of the other vehicle OV) before colliding with another vehicle OV becomes less than the first threshold value TTCth, the “automatic brakie that causes the magnitude of deceleration of the host vehicle HV to become the first predetermined value A1” is applied to the host vehicle HV or the host vehicle HV is steered relatively slightly so as to avoid the collision with the other vehicle OV. This control is the example of the standard collision avoidance control (i.e., first assistance control) as the driving assistance control. It should be noted that the margin time TTC is one of collision possibility indicating values that indicate a collision possibility.

In the case 2 shown in FIG. 5A, the road ahead of the host vehicle HV has a peculiar shape. Thus, even when an other vehicle OV is running in the oncoming lane OL, the host vehicle HV and the other vehicle OV have the same positional relationship as in the case 1. In this case, if the standard collision avoidance control is performed, that standard collision control is an unnecessary/unwanted control. In view of this, when the host vehicle HV travels in the specific region (refer to an area encompassed by the broken line AR1) that includes a road having such a peculiar shape (i.e., the road having a shape that causes the other vehicle OV to come closer to the front face of the host vehicle HV), the apparatus DS performs the second assistance control based on the electronic data that has been received from the server 100a of the management center 100 in advance and been available. Namely, the apparatus DS performs, as the second assistance control, a driving assistance control for the specific region AR1, that is, a collision avoidance control optimized for the specific region AR1. For example, the second assistance control is a control to execute an automatic brake to cause the deceleration of the host vehicle HV to coincide with a second predetermined value A2 larger than the first predetermined value A1 when the margin time TTC becomes shorter than or equal to a second threshold TTCth that is smaller than the first threshold TTCth. The second assistance control may be a control to steer the host vehicle HV relatively greatly to avoid the collision with the other vehicle OV when the margin time TTC becomes shorter than or equal to the second threshold TTCth.

### (Example 2) Cross Traffic Alert (Crossing Object Alert Assistance Control)

A cross traffic alert is a driving assistance control that alerts the driver of the host vehicle HV when an object is expected to cross the line segment from a point of the front center of the host vehicle to a point a distance D away from the point of the front center within a predetermined time. The distance D is determined based on a width of the lane.

For example, if the vehicle is sold in a certain area (e.g., a certain country) A, as the case 3 shown in FIG. 5B, the lane width in that area is W1, and the above-described distance D is set to a distance D1 which is 1.5 times longer than the lane width W1. Accordingly, the cross traffic alert using the distance D1 is performed as the first standard control (i.e., the standard driving assistance control).

When the host vehicle HV enter a specific region (e.g. a country) B next to the certain area A, as the case 4 shown in FIG. 5B, the lane width in that specific region B is W2 that is wider than the W1, and the above-described distance D is set to a distance D2 which is 1.5 times longer than the lane width W2. Accordingly, the cross traffic alert using the distance D2 is performed as the second assistance control (i.e., the driving assistance control optimized for the specific region). The electronic data to perform this second assistance control is downloaded in advance from the server 100a of the management center 100.

### (Example 3) an Alert Control for a Cut-In Vehicle

The alert control for a cut-in vehicle is a control to notify the driver of the host vehicle HV that there is a cut-in vehicle, when the host vehicle is running in a first lane and an adjacent vehicle is running in a second lane adjacent to the first lane on a road having two or more lanes in one direction, and when it is predicted the adjacent vehicle is likely to cut in in front of the host vehicle HV.

Usually, a driver of the adjacent vehicle flickers turn signals of the side of the cutting-in before the driver performs an operation for cutting in. In view of this, the apparatus DS alerts the driver of the host vehicle HV that there is a cut-in vehicle when the turn signals in the first lane side of the adjacent vehicle running in the second lane are flickering and a lateral movement amount of the adjacent vehicle toward the first lane becomes equal to or greater than a first threshold. This control is the alert control (i.e., first assistance control) for a cut-in vehicle as the standard driving assistance control.

Whereas, in a specific region (i.e., specific area), due to a traffic regulation of that specific region or a driving practice of that specific region, the driver of the adjacent vehicle does not flicker the turn signals when he/she performs the cut-in operation. In view of this, when the host vehicle HV is located in that specific region, the apparatus DS alerts the driver of the host vehicle HV that there is a cut-in vehicle when the lateral movement amount of the adjacent vehicle toward the first lane becomes equal to or greater than a second threshold which is the same as or different from the first threshold and a change amount per unit time in lateral movement amount of the adjacent vehicle toward the first lane becomes equal to or greater than a change amount threshold, regardless of whether or not the turn signals in the first lane side of the adjacent vehicle running in the second lane are flickering. This control is the alert control for a cut-in vehicle in the specific region (i.e., second assistance control) as the driving assistance control optimized for the specific region. The electronic data (in this case, programs) to perform this second assistance control is downloaded in advance from the server 100a of the management center 100.

### (Example 4) an Adaptive Cruise Control (ACC)

Usually, the ACC is a control designed/tuned in such a manner that the host vehicle HV can run on a limited highway (e.g., an express highway) appropriately. In other words, the ACC having various constants (e.g., a gain for determining an acceleration) that have been set on the assumption that the host vehicle HV runs on the limited highway is the standard driving assistance control (the first assistance control).

Whereas, in the specific region, the ACC is also often used in a general road, because, for example, a volume of traffic is relatively small or there are a lot of straight roads. In this case, decrease of the number of lanes are frequently happens, or a lot of cut-in vehicles are present. In view of this, when the host vehicle HV travels in the specific region, the ACC having various constants determined on the assumption that the host vehicle HV runs on the general road is performed as the driving assistance control optimized for that specific region (the second assistance control). The electronic data to perform this second assistance control is downloaded in advance from the server 100a of the management center 100.

### (Example 5) a Collision Avoidance Control for a Pedestrian and an Animal

Usually, when a moving object is present in the vicinity of the host vehicle HV, the apparatus DS determines based on the camera information whether or not the moving object is a pedestrian. If the apparatus DS determines that the moving object is a pedestrian, the apparatus DS alerts the driver of the host vehicle HV and applies the automatic brake to the host vehicle HV, when the distance between the host vehicle HV and the pedestrian becomes shorter than or equal to a distance threshold. Whereas, when the moving object is an animal other than the pedestrian, the apparatus DS does not perform the above-described alert and the above-described automatic brake, since there is a possibility that the apparatus DS erroneously recognizes that the object which is actually is an object other than the animal or which is a billboard is an animal and there is low possibility that the animal is present on the road. This control is the standard collision avoidance control (i.e., first assistance control) for a pedestrian and an animal.

Whereas, in a specific region (e.g. mountain), a possibility that an animal is present on a road is high. Therefore, when the host vehicle HV travels in such a specific region, the apparatus DS performs a collision avoidance control for an animal in addition to the above-described collision avoidance control for a pedestrian. Specifically, the apparatus DS determines whether or not the moving object is a specific animal (e.g., a deer, a monkey, or a bison) other than a pedestrian based on the camera information, the apparatus DS immediately alerts the driver of the host vehicle HV and applies the automatic brake to the host vehicle HV when the apparatus determines that the moving object is the specific animal, regardless of a distance between the host vehicle HV and the specific animal. This control is the collision avoidance control for a pedestrian and an animal (the second assistance control). The electronic data to perform this second assistance control is downloaded in advance from the server 100a of the management center 100.

As has been described above, the embodiment of the present disclosure can perform driving assistance controls appropriate/suitable for specific regions, while enjoying the following effects.
The memory capacity of the memory of the host vehicle HV (in this case, the nonvolatile memory 10d) is not subject to significant constraints. In other words, the memory capacity of the nonvolatile memory 10d does not have to be very large.
It is substantially difficult/impossible that every suitable driving assistance control suitable for characteristic of each of regions is developed based on the characteristic of each of the regions and is installed in the host vehicle before the vehicle HV is introduced into the market (in other words, it is impossible that electronic data to perform driving controls suitable for the characteristics of all of the regions is installed/stored in the on-board memory before the shipment of the host vehicle HV), however, the embodiment of the present disclosure can perform driving assistance controls suitable for characteristics of all of the regions.
Even when road environments or traffic regulations are changed after the host vehicle HV is introduced into the market, driving assistance controls optimized for that changes can be readily performed.

It should be noted that the present disclosure is not limited to the above embodiment, and may adopt various modifications within the scope of the present disclosure.

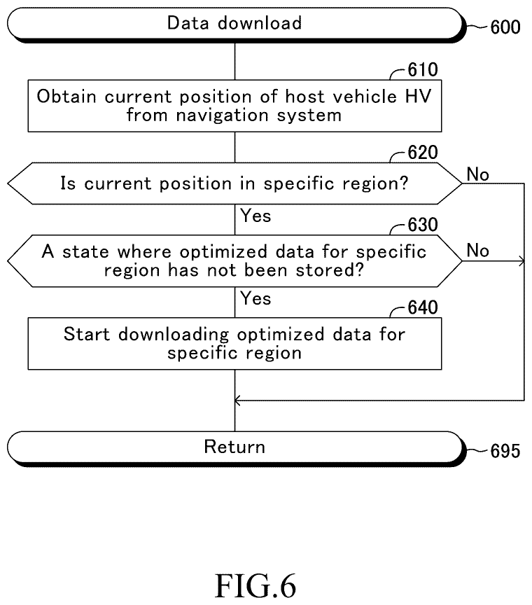

For example, as shown in FIG. 6, the CPU of the above-described apparatus DS may download the optimized data for the specific regions regardless of whether or not the planed travel route has been set on the on-board navigation system. Specifically, the CPU obtains the current position of the host vehicle HV every time a predetermined time elapses (S610), determines whether or not the current position of the host vehicle HV is in the specific region (S620), determines whether or not the optimized data for that specific region has been stored/held in the nonvolatile memory 10d when the current position of the host vehicle HV is in the specific region (S630), and starts downloading the optimized data for that specific region when the optimized data for that specific region has not been stored/held in the nonvolatile memory 10d (S640). Furthermore, in both of a case where the current position of the host vehicle HV is not in the specific region (620: No) and a case where the optimized data for that specific region has been stored/held in the nonvolatile memory 10d (S630: No), the CPU does not start downloading the optimized data. According to this modification, the first assistance control is performed until a time point at which the optimized data comes to be able to be used (or to become available) after the optimized data starts to be downloaded. In addition, the second assistance control is performed after the time point at which the optimized data comes to be able to be used (or to become available) by the driving assistance ECU 10. It should be noted that the routine shown in FIG. 6 may also be executed when the above-mentioned ignition key switch is switched from the off position to the on position.

Furthermore, the present disclosure can be applied to an autonomous driving vehicle, when the vehicle driving mode of that autonomous driving vehicle is changed from an autonomous driving mode to a mode where the driver drives that autonomous vehicle.

What is claimed is:

1. A driving assistance control apparatus comprising a controller configured to:
when a host vehicle is located in a normal region other than a specific region, perform a first assistance control which is a standard driving assistance control based on electronic data stored in a memory before factory shipment of said host vehicle; and
when said host vehicle is located in said specific region, perform, in place of said first assistance control, a second assistance control which is a driving assistance control for said specific region using electronic data that is received from a server external to said host vehicle.

2. The driving assistance control apparatus according to claim 1, wherein,
when a planned travel route of said host vehicle is a route passing through said specific region, said controller is configured to complete receiving said electronic data from said server before a time point at which said host vehicle enters said specific region.

3. The driving assistance control apparatus according to claim 2,
wherein,
when said controller determines that said controller can receive said electronic data and set said electronic data in such a manner that said controller can use said electronic data in a period from a time point at which said controller recognizes that said planned travel route of said host vehicle is said route passing through said specific region to a time point at which said host vehicle is predicted to reach said specific region, said controller is configured to complete receiving said electronic data from said server and complete setting said electronic data in such a manner that said controller can use said electronic data.

4. The driving assistance control apparatus according to claim 1,
wherein,
said controller is configured to:
store temporarily said electronic data received from said server in a memory; and
delete said electronic data stored in said memory to perform said second assistance control from said memory, when said host vehicle has left said specific region where said second assistance control was being performed, said planned travel route includes another specific region, and there is not enough memory capacity to store electronic data for performing a third assistance control for that another specific region.

5. The driving assistance control apparatus according to claim 1,
wherein,
said controller is configured to:
perform a first collision avoidance assistance control as said first assistance control, when an other vehicle is located in a travel direction of said host vehicle and a collision possibility indicating value indicative of a possibility that said other vehicle collides with said host vehicle satisfies a predetermined first condition; and
determine that said host vehicle is located in said specific region when said host vehicle is located in a region that includes a road with a shape that causes said other vehicle to come closer to a front face of said host vehicle, and perform a second collision avoidance assistance control as said second assistance control when said collision possibility indicating value satisfies a second condition that is set based on said electronic data received from said server.

6. A driving assistance control method comprising:
a step of performing a first assistance control which is a standard driving assistance control based on electronic data stored in a memory before factory shipment of a host vehicle, when a host vehicle is located in a normal region other than a specific region; and
a step of performing, in place of said first assistance control, a second assistance control which is a driving assistance control for said specific region using electronic data that is received from a server external to said host vehicle, when said host vehicle is located in said specific region.

7. The driving assistance control method according to claim 6 further comprising:
a step of completing receiving said electronic data from said server before a time point at which said host vehicle enters said specific region, when a planned travel route of said host vehicle is a route passing through said specific region.

8. A non-transitory storage medium storing a program for a driving assistance control, said program causing a computer to implement:
a step of performing a first assistance control which is a standard driving assistance control based on electronic data stored in a memory before factory shipment of a host vehicle, when a host vehicle is located in a normal region other than a specific region; and
a step of performing, in place of said first assistance control, a second assistance control which is a driving assistance control for said specific region using electronic data that is received from a server external to said host vehicle, when said host vehicle is located in said specific region.

9. The non-transitory storage medium according to claim 8, said program further causing said computer to implement:
a step of completing receiving said electronic data from said server before a time point at which said host vehicle enters said specific region, when a planned travel route of said host vehicle is a route passing through said specific region.
